(19) United States
(12) Patent Application Publication
(10) Pub. No.: US 2008/0180853 A1
(43) Pub. Date: Jul. 31, 2008

(54) ACTUATOR LATCH APPARATUS AND HARD DISK DRIVE APPARATUS HAVING THE SAME

(75) Inventors: Jung Moo SON, Gunpo-si (KR); Do Wan Kim, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/022,525

(22) Filed: Jan. 30, 2008

(30) Foreign Application Priority Data
Jan. 31, 2007 (KR) 2007-10157

(51) Int. Cl. G11B 5/54

(52) U.S. Cl. 360/256.2

(57) ABSTRACT

An actuator latch apparatus usable with a hard disk drive apparatus includes a latch lever disposed on a base to pivot thereon and having a first latch prevention portion to prevent pivoting of an actuator arm in a direction, the actuator arm having a bobbin formed at a rear end portion thereof, and a bobbin protruding portion having a first catch portion provided at the bobbin and an auxiliary catch portion provided at the bobbin separated from the first catch portion to lock with the first latch prevention portion when the first catch portion is not caught by the first latch prevention portion.

### CROSS-REFERENCE TO RELATED APPLICATIONS

This application claims the priority under 35 U.S.C. §119(a) from Korean Patent Application No. 10-2007-0010157, filed on 31 Jan. 2007, in the Korean Intellectual Property Office, the disclosure of which is incorporated herein in its entirety by reference.

### BACKGROUND OF THE INVENTION

1. Field of the Invention

The present general inventive concept relates to an actuator latch apparatus and a hard disk drive apparatus having the same, and more particularly, to an actuator latch apparatus in which a latch lever can prevent rotation of an actuator when an abnormal rotary shock is applied, and a hard disk drive apparatus having the actuator latch apparatus.

2. Description of the Related Art

Hard disk drive apparatus (HDDs) formed of electronic parts and mechanical parts are memory devices to record and reproduce data by converting digital electric pulses to a magnetic field that is more permanent. The HDDs are widely used as auxiliary memory devices of computer systems because of fast access time to a large amount of data.

With the recent increase in TPI (track per inch; a density in a radial direction of a disk) and BPI (bits per inch; a density in a rotational direction of a disk), the HDD has achieved a high capacity and its application field has expanded. Accordingly, there has been a request for development of compact HDDs that can be used for portable electronic products such as notebooks, personal digital assistants (PDAs), and mobile phones.

A typical HDD includes a disk pack having a disk recording data and a spindle motor rotating the disk with respect to a shaft, an actuator having a read/write head that records data on a recording surface of the disk or reproduces the data recorded on the recording surface of the disk, a voice coil motor (VCM) pivoting the actuator, and a base on which these parts are installed. In the HDD configured as described above, the read/write head is maintained at a predetermined height above the recording surface of the disk that is rotating and moves to a desired position by the bidirectional pivoting of the actuator to perform a data recording and reproducing operation.

When the HDD is not operated, that is, the rotation of the disk is stopped, the read/write head is parked at a position away from the recording surface of the disk so that the read/write head does not collide against the recording surface of the disk. The parking system of the read/write head includes a contact start stop (CSS) method and a ramp loading method. In the CSS method, a parking zone where data is not recorded is provided at the inner circumferential side of the disk and the read/write head is parked in contact with the parking zone. In the ramp loading method, the read/write head is parked on a ramp installed outside the disk so that an end tap that is a leading end of the actuator is supported on the ramp.

However, when a rotary shock is applied to the HDD in a state in which the read/write head is parked in the parking zone of the disk or on the ramp, the actuator arbitrarily rotates to move over the recording surface of the disk so that the read/write head and the recording surface of the disk can be damaged. Thus, there is a need to lock the actuator at a particular position and not to arbitrarily rotate it when the rotation of the disk stops and the read/write head is parked in the parking zone of the disk or on the ramp. For this purpose, a variety of latch apparatuses locking the actuator are provided in the HDD.

FIGS. 1, 2, and 3 illustrate an operation of a single lever latch apparatus for a conventional hard disk drive apparatus. Referring to FIGS. 1 to 3, a single lever inertia latch apparatus 103 according to prior art includes a bobbin protruding portion 170 formed on a bobbin 146 of an actuator arm 143 and having a catch portion 171, and a latch lever 180 having a latch prevention portion 183 preventing the catch portion 171 to prevent pivoting of the actuator arm 143 in a direction. The latch lever 180 includes a pivot center portion 181 that is the center of pivoting, a latch arm 182 having the latch prevention portion 183 at the leading end portion thereof, and a latch lever elastic portion 172 provided at the other end of the latch arm 182 and restricting the pivoting of the actuator arm 143 in the other direction. The latch lever 180 is disposed at a base (not illustrated) capable of pivoting.

When a rotary shock in a clockwise direction is applied to the HDD having the single lever inertia latch apparatus 103, as illustrated in FIG. 2, the actuator 140 and the latch lever 180 pivot counterclockwise due to inertia. Accordingly, the catch portion 171 of the bobbin protruding portion 170 is caught by the latch prevention portion 183 of the latch lever 180 so that the actuator arm 143 does not pivot any longer. That is, the read/write head of the actuator arm 143 is not deviated from the parking zone of the disk or the ramp.

Conversely, when a rotary shock counterclockwise is applied to the HDD, the actuator arm 143 and the latch lever 180 pivot clockwise due to the inertia. The actuator arm 143 first pivots clockwise and then bumps into the latch lever elastic portion 172 and is rebounded to pivot counterclockwise. The latch lever 180 bumps with an inner wall of the base or a latch stop (not illustrated) protruding from the inner wall of the base to pivot counterclockwise. Thus, the catch portion 171 of the bobbin protruding portion 170 is caught by the latch prevention portion 183 of the latch lever 180 and the actuator arm 143 maintains a locking state.

However, in the single lever inertia latch apparatus 103 configured as described above, when a rotary shock is applied to the HDD, if a rebounding timing for the latch lever 180 to rebound from the inner wall of the base or the latch stop and return to the original position is longer than a rebounding time for the actuator 140 to rebound from the latch lever elastic portion 172 and return to the original position, as illustrated in FIG. 3, the latch lever 180 cannot prevent pivoting of the actuator arm 143. Thus, the read/write head of the actuator arm 143 escapes from the parking zone of the disk or ramp to move over the recording surface of the disk, which is referred to as a disk on pack phenomenon, so that the disk can be damaged and the reliability of the HDD can be deteriorated.

### SUMMARY OF THE INVENTION

The present general inventive concept provides an actuator latch apparatus usable with a hard disk drive apparatus that can reduce a disk on pack phenomenon that a leading end portion of an actuator arm moves over a recording surface of a disk when the actuator arm is rebounded due to a rotary shock, with a structure that is simple and easy to manufacture, so that locking failure is prevented and reliability in locking and unlocking operations is improved, and a hard disk drive apparatus having the actuator latch apparatus.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an actuator latch apparatus usable in a hard disk drive apparatus, including a latch lever disposed on a base to pivot thereon and having a first latch prevention portion to prevent pivoting of an actuator arm in a direction, the actuator arm having a bobbin formed at a rear end portion thereof, and a bobbin protruding portion having a first catch portion provided at the bobbin and an auxiliary catch portion provided at the bobbin separated from the first catch portion to lock with the first latch prevention portion when the first catch portion is not caught by the first latch prevention portion.

The auxiliary catch portion may be at least one auxiliary catch groove formed indented on a side surface of the bobbin protruding portion toward the bobbin.

The at least one auxiliary catch groove may have a saw-toothed shape in which a depth of the indent gradually decreases toward the first latch prevention portion of the latch lever.

Corner portions of the at least one auxiliary catch groove may be round processed.

The at least one auxiliary catch groove may be provided in a plural number close to the first catch portion to be separated from each other along a side surface of the bobbin protruding portion facing the latch lever.

The latch lever may further include a latch arm disposed on the base to pivot thereon and having the first latch prevention portion provided at an end portion, and the first latch prevention portion may include a first latch hook protruding from an end portion of the latch arm, and a second latch hook protruding from the latch arm at a position close to the first latch hook.

The first latch prevention portion may further include a third latch hook protruding from the latch arm at a position close to the second latch hook.

A latch lever time protrusion may protrude from a surface of the latch lever facing an inner wall of the base and a base time protrusion may be provided on the base facing the latch lever time protrusion so that the latch lever time protrusion contacts the base time protrusion before the latch lever rotates in a direction and is rebounded to return to an original position.

The latch lever may further include a second latch prevention portion coupled to the second catch portion provided at an opposite side of the first catch portion of the bobbin protruding portion, to prevent the pivoting of the actuator arm in an other direction.

The latch lever may further include a buffer arm provided by a slot formed at a side of the latch lever and the second latch prevention portion is provided at the buffer arm.

The foregoing and/or other aspects and utilities of the general inventive concept may also be achieved by providing hard disk drive apparatus includes a base, an actuator arm disposed on a base to pivot thereon and having a bobbin formed at a rear end portion thereof, a latch lever disposed on the base to pivot thereon and having a first latch prevention portion to prevent pivoting of an actuator arm in a direction, and a bobbin protruding portion having a first catch portion provided at the bobbin and an auxiliary catch portion provided at the bobbin separated from the first catch portion to lock with the first latch prevention portion when the first catch portion is not caught by the first latch prevention portion.

The auxiliary catch portion may be at least one auxiliary catch groove formed indented on a side surface of the bobbin protruding portion toward the bobbin.

The at least one auxiliary catch groove may have a saw-toothed shape in which a depth of the indent gradually decreases toward the first latch prevention portion of the latch lever.

Corner portions of the at least one auxiliary catch groove may be round processed.

The at least one auxiliary catch groove may be provided in a plural number close to the first catch portion to be separated from each other along a side surface of the bobbin protruding portion facing the latch lever.

The latch lever may further include a latch arm disposed on the base to pivot thereon and having the first latch prevention portion provided at an end portion, and the first latch prevention portion may comprise a first latch hook protruding from an end portion of the latch arm, and a second latch hook protruding from the latch arm at a position close to the first latch hook.

The first latch prevention portion may further include a third latch hook protruding from the latch arm at a position close to the second latch hook.

A latch lever time protrusion may protrude from a surface of the latch lever facing an inner wall of the base and a base time protrusion may be provided on the base facing the latch lever time protrusion so that the latch lever time protrusion contacts the base time protrusion before the latch lever rotates in a direction and is rebounded to return to an original position.

The latch lever may further include a second latch prevention portion coupled to the second catch portion provided at an opposite side of the first catch portion of the bobbin protruding portion, to prevent the pivoting of the actuator arm in an other direction.

The latch lever may further include a buffer arm provided by a slot formed at a side of the latch lever and the second latch prevention portion is provided at the buffer arm.

The foregoing and/or other aspects and utilities of the general inventive concept may also be achieved by providing a latch apparatus usable with a disk drive apparatus having a base, the latch apparatus including a latch lever pivotably coupled to the base and having one of a plurality of prevention portions and a plurality of catch portions, and an actuator arm pivotably coupled to the base portion and having the other one of the plurality of prevention portions and the plurality of catch portions, wherein a respective one of the plurality of prevention portions and a respective one of the plurality of catch portions engage each other to limit at least one of a clockwise direction and a counterclockwise direction of the actuator arm in response to a shock applied to the disk drive apparatus while in a parking mode.

The foregoing and/or other aspects and utilities of the general inventive concept may also be achieved by providing a disk drive apparatus having a parking mode, the apparatus including a base, and a latch apparatus usable with a disk drive apparatus including a latch lever pivotably coupled to the base and having one of a plurality of latch prevention portions and a plurality of catch portions, and an actuator arm pivotably coupled to the base portion and having the other one of the plurality of latch prevention portions and the plurality of catch portions, wherein a respective one of the plurality of prevention portions and a respective one of the plurality of catch portions engage each other to limit pivoting of the actuator arm in at least one of a clockwise direction and a counterclockwise direction in response to a shock applied to the disk drive apparatus while in the parking mode.

The foregoing and/or other aspects and utilities of the general inventive concept may also be achieved by providing a latch apparatus usable with a disk drive apparatus including a latch lever having a latch prevention portion and an actuator arm having a bobbin protruding portion having a first circumferential length in a rotation direction of the actuator arm, and first and second catch portions disposed on the bobbin protruding portion and spaced-apart from each other by a second circumferencial length shorter than the first circumferencial length in the rotational direction of the actuator arm selectively caught by the latch lever.

### BRIEF DESCRIPTION OF THE DRAWINGS

The above and/or other aspects and utilities of the present general inventive concept will become apparent and more readily appreciated from the following detailed description, taken in conjunction with the accompanying drawings of which:

FIGS. 1, 2, and 3 illustrate an operation of a single lever latch apparatus for a conventional hard disk drive apparatus;

FIG. 4 is a partially explode perspective view illustrating a hard disk drive apparatus according to an embodiment of the present general inventive concept;

FIG. 5 is a plan view illustrating the hard disk drive apparatus of FIG. 4;

FIG. 6 is a partially enlarged perspective view illustrating the hard disk drive apparatus of FIG. 4;

FIG. 7 is a plan view illustrating the hard disk drive apparatus of FIG. 6;

FIG. 8 illustrates an operation of a first latch prevention portion of a latch lever caught by an auxiliary catch portion of the bobbin protruding portion of FIG. 4; and

FIG. 9 illustrates an uneven shape of an auxiliary catch portion of a hard disk drive apparatus according to another embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

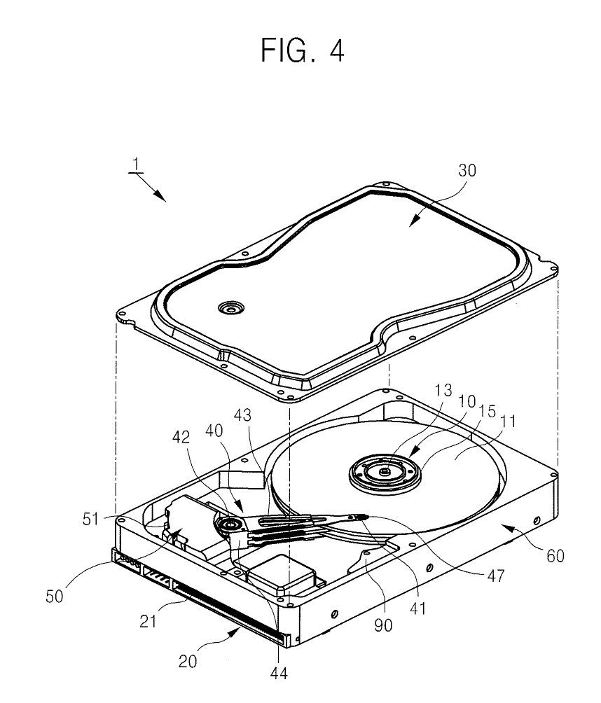

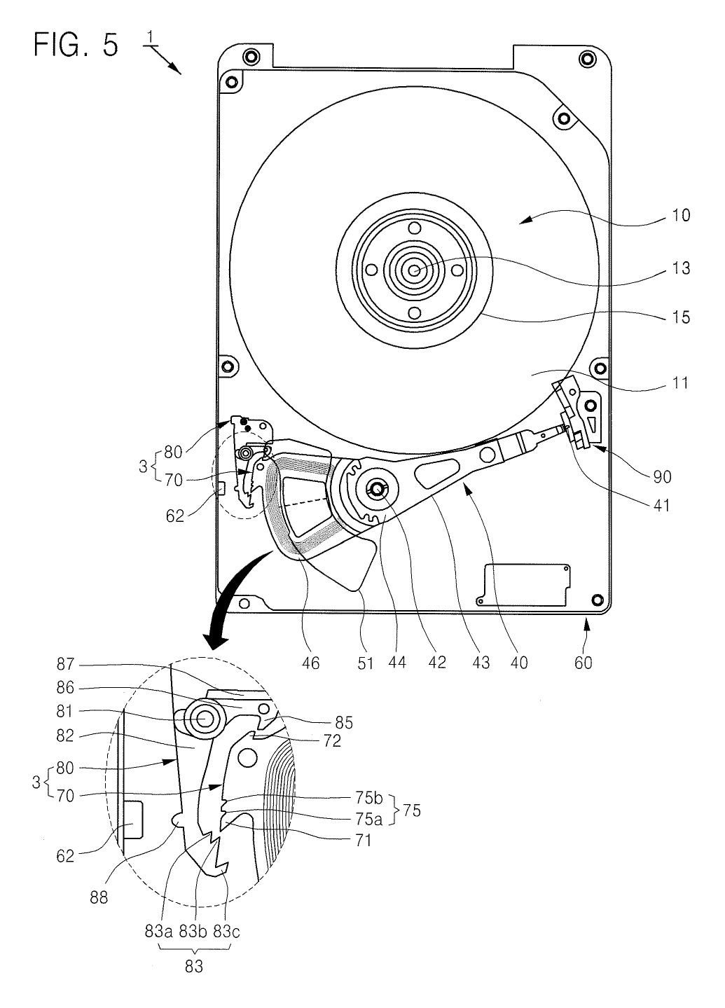

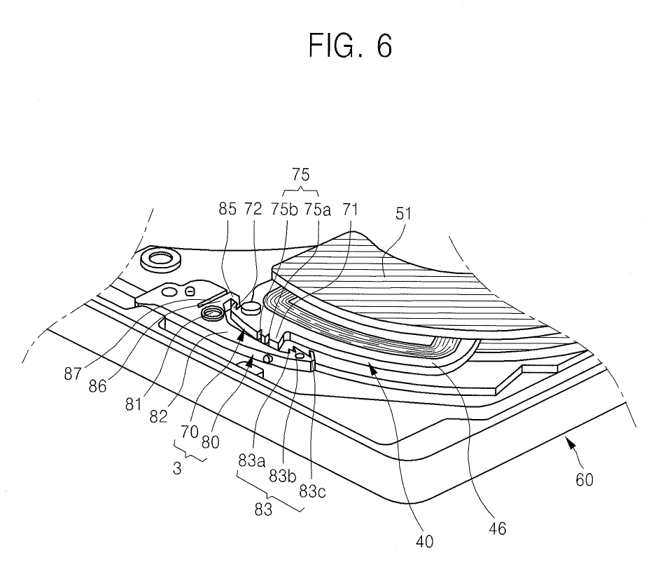

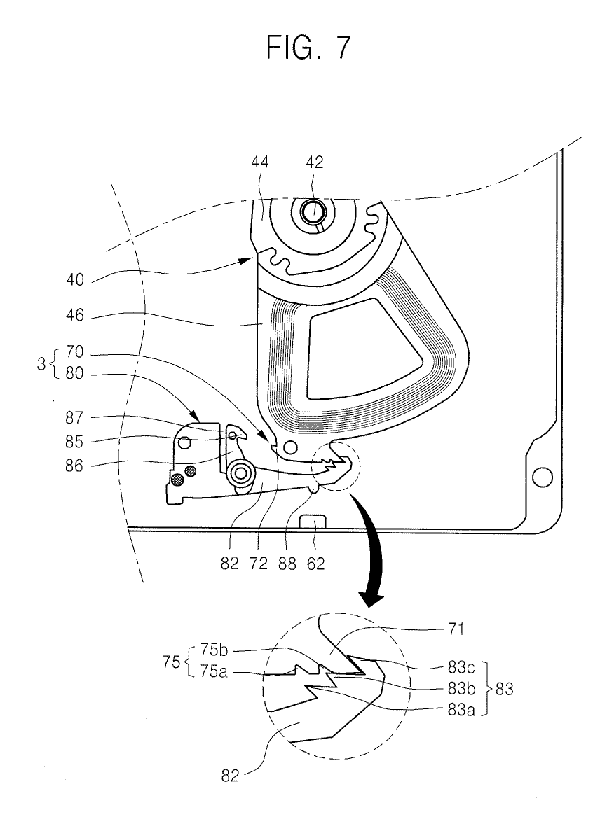

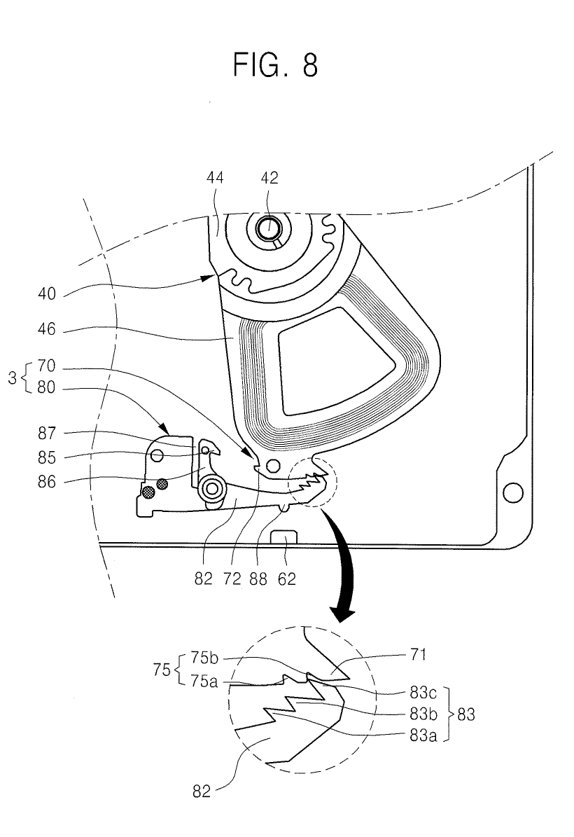

FIG. 4 is a partially explode perspective view illustrating a hard disk drive apparatus (HDD) 1 according to an embodiment of the present general inventive concept. FIG. 5 is a plan view illustrating the HDD of FIG. 4. FIG. 6 is a partially enlarged perspective view illustrating the HDD of FIG. 4. FIG. 7 is a plan view illustrating the HDD of FIG. 6. FIG. 8 illustrates an operation of a first latch prevention portion of a latch lever caught by an auxiliary catch portion of the bobbin protruding portion of FIG. 4.

Referring to FIGS. 4 to 8, the HDD 1 according to the present embodiment includes a disk pack 10, a printed circuit board assembly (PCBA) 20, a cover 30, a head stack assembly (HSA) 40 moving a read/write head 41 recording and reproducing data with respect to a disk 11 to a predetermined position on the disk 11, a voice coil motor (VCM) 50 pivoting an actuator arm 43 of the HSA 40, a ramp 90 parking the read/write head 41 by supporting an end tap 47 formed at a leading end portion of the actuator arm 43 when the disk 11 is stopped, and a base 60 supporting these units.

The disk pack 10 includes a shaft 13 forming a rotational center of the disk 11, a spindle motor hub (not illustrated) provided outside the shaft 13 in a radial direction and supporting the disk 11, a clamp 15 coupled to an upper portion of the spindle motor hub, and a clamp screw (not illustrated) pressing the clamp 15 to make the disk 11 be fixed to the spindle motor hub.

The PCBA 20 includes a printed circuit board (PCB, not illustrated) having a plate shape, and a PCB connector 21 provided at a side of the PCB. The PCB includes a plurality of chips and circuits (not illustrated) to control the disk 11 and the read/write head 41 and tranceives signals with the outside through the PCB connector 21.

The cover 30 covers the upper surface of the base 60 and forms an accommodation space to accommodate the disk pack 10 and the HSA 40. Thus, various units accommodated in the accommodation space are protected.

The HSA 40 is a carriage to write data to the disk 11 or read the data from the disk 11 and includes the read/write head 41 to read and write data with respect to the disk 11, the actuator arm 43 pivoting across the disk 11 around a pivot shaft 42 so that the read/write head 41 accesses the data on the disk 11, a suspension (not illustrated) coupled to the end portion of the actuator arm 43, a pivot shaft holder 44 to rotatably support the pivot shaft 42 and to support the actuator arm 43 coupled thereto, and a bobbin 46 provided at an opposite position of the actuator arm 43 with respect to the pivot shaft holder 44 and between magnets (not illustrated) of the VCM 50.

The read/write head 41 reads or writes information with respect to the disk 11 that rotates by detecting a magnetic field formed on the surface of the disk 11 or magnetizing the surface of the disk 11. The read/write head 41 includes a read head to detect the magnetic field of the disk 11 and a write head to magnetize the disk 11.

The VCM 50 is a drive motor pivoting the actuator arm 43 to move the read/write head 41 to a desired position on the disk 11 and uses Fleming's left hand rule, that is, a principle that an electromotive force is generated when current flows in a conductive body present in a magnetic field.

Thus, when power is applied to the HDD 1 and the disk 11 rotates, the read/write head 41 coupled to a leading end portion of the actuator arm 43 is lifted by a lift force generated during the rotation of the disk 11 and maintained at a predetermined height so as to write data to the disk 11 or read data from the disk 11.

Conversely, when the power supplied to the HDD is cut off and the disk 11 stops rotating, the actuator arm 43 is rotated around the pivot shaft 42 and parked on the ramp 90. When an external rotary shock or vibration is applied to the HDD 1, the end tab 47 formed at the leading end portion of the actuator arm 43 is detached from the ramp 90. Accordingly, the actuator arm 43 pivots toward the disk 11 so that the read/write head 41 may be moved above the recording surface of the disk 11. In general, since the disk 11 is stopped, the read/write head 41 cannot be lifted to a predetermined lift height. Thus, an interference is generated between the read/write head 41 and the recording surface of the disk 11 so that the read/write head 41 or the disk 11 can be damaged. Furthermore, the reliability of the HDD 1 can be deteriorated.

Thus, the HDD 1 according to the present embodiment further includes a latch apparatus 3 that can prevent interference between the actuator arm 43 and the disk 11 so that parking of the actuator arm 43 can be maintained when the rotary shock is generated.

The latch apparatus 3 according to an embodiment of the present embodiment, as illustrated in FIGS. 4 to 8 includes, a latch lever 80 having a first latch prevention portion 83 and a second latch prevention portion 85 that are disposed at the base 60 capable of pivoting and prevent the pivoting of the actuator arm 43 when the disk 11 is stopped, and a bobbin protruding portion 70 provided at the rear end portion of the actuator arm 43. The bobbin protruding portion 70 includes a first catch portion 71 and a second catch portion 72 that are respectively caught by the first latch prevention portion 83 and the second latch prevention portion 85 and an auxiliary catch portion 75 which catches a leading end portion of the first latch prevention portion 83.

The latch lever 80 is coupled to the base 60 at a position close to a VCM yoke 51 to be capable of pivoting and, as illustrated in FIGS. 6 and 7, includes a pivot center portion 81 that is the center of pivot, a latch arm 82 coupled to the pivot center portion 81 to be capable of pivoting, a first latch prevention portion 83 provided at the leading end portion of the latch arm 82 and caught by the first catch portion 71 of the bobbin protruding portion 70 when the actuator arm 43 rotates counterclockwise, a second latch prevention portion 85 provided at the rear end portion of the latch arm 82 and caught by the second catch portion 72 when the actuator arm 43 rotates clockwise, and a latch lever time protrusion 88 formed on a surface of the latch arm 82 facing the inner wall of the base 60 and shortening the pivot distance of the latch arm 82.

In the latch lever 80 configured as described above, when an external rotary shock in the clockwise or counterclockwise is applied to the HDD 1, inertia is generated to make the latch lever 80 to pivot in a direction opposite to a direction in which the external force is applied. The inertia couples the first catch portion 71 and the first latch prevention portion 83, or the second catch portion 72 and the second latch prevention portion 85, to be latched, so that the arbitrary pivot of the actuator arm 43 is prevented.

In detail, the first latch prevention portion 83 catches the first catch portion 71 of the bobbin protruding portion 70 or is caught by the auxiliary catch portion 75 of the bobbin protruding portion 70. The first latch prevention portion 83 prevents the arbitrary pivoting of the actuator arm 43 counterclockwise when the disk 11 is stopped.

The first latch prevention portion 83, as illustrated in FIG. 7, includes a first latch hook 83a protruding from the latch arm 82 to be available to hook the first catch portion 71 in when the first catch portion 71 of the bobbin protruding portion 70 rotates counterclockwise, a second latch hook 83b protruding from the latch arm 82 at a position close to the first latch hook 83a and hooking the first catch portion 71 when the first latch hook 83a fails to hook the first catch portion 71, and a third latch hook 83c protruding from the latch arm 82 at a position close to the second latch hook 83b and hooking the first catch portion 71 when the first latch hook 83a and the second latch hook 83b fail to hook the first catch portion 71.

Even when the first latch hook 83a fails to prevent the pivoting of the actuator arm 43 because of the rebounding timing (timing to return to an original position after pivoting in a predetermined direction by a shock) of the first latch prevention portion 83 and the first catch portion 71 do not match each other due to the first latch prevention portion 83 having the above described structure, since the second latch hook 83b located closer to the leading end than the first latch hook 83a is caught by the first catch portion 71, the pivoting of the actuator arm 43 can be prevented.

Also, when the second latch hook 83b fails to prevent the pivoting of the actuator arm 43 because the rebounding timing between the first catch portion 71 and the second latch hook 83b do not match each other, since the third latch hook 83c located closer to the leading end than the second latch hook 83b catches the first catch portion 71, the pivoting of the actuator arm 43 can be prevented.

The second latch prevention portion 85 is a portion where the second catch portion 72 of the bobbin protruding portion 70 is hooked, that prevents the pivoting of the actuator arm 43 clockwise. The second latch prevention portion 85 is provided at a buffer arm 86 and can reduce the shock generated during the rebounding between the second catch portion 72 and the second latch prevention portion 85. The buffer arm 86 is provided at a slot 87 formed at a side of the latch lever 80 and may be formed of polyimide having elasticity.

In an embodiment of the present general inventive concept, to make the bobbin protruding portion 70 of the actuator arm 43 caught by the first latch prevention portion 83, a method of accurately matching the rebounding time of the first catch portion of the bobbin protruding portion 70 and the first latch prevention portion 83 of the latch lever 80 can be adopted. When rotating clockwise, the actuator arm 43 is caught by the second latch prevention portion 85 or rebounded to pivot counterclockwise. Simultaneously, the latch lever 80 pivots clockwise rotation and is rebounded to return to the original position. Only when the latch lever 80 is quickly rebounded to return to the original position, the pivoting of the actuator arm 43 can be prevented more effectively.

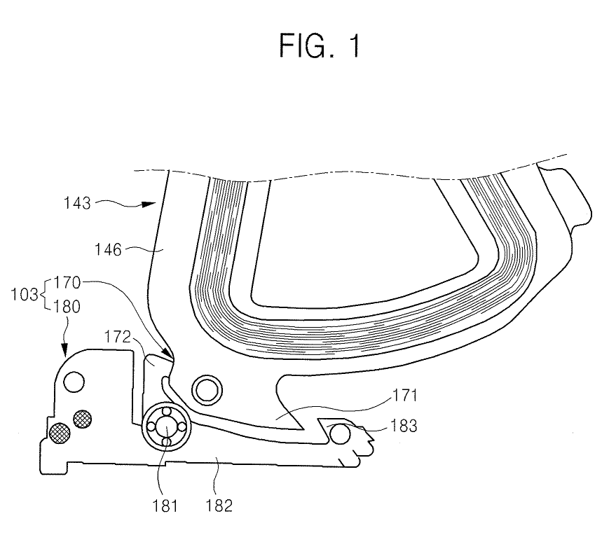

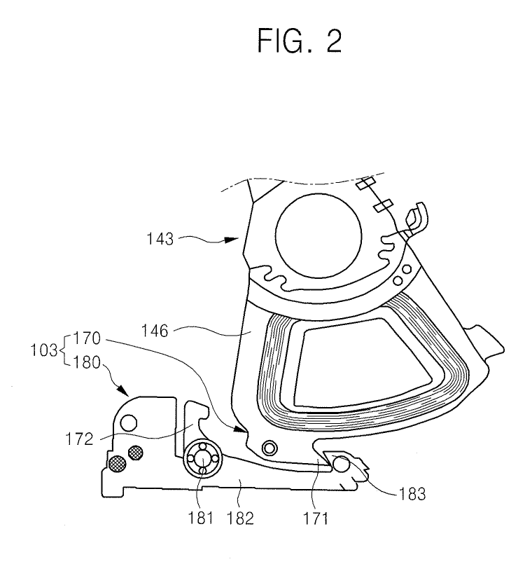

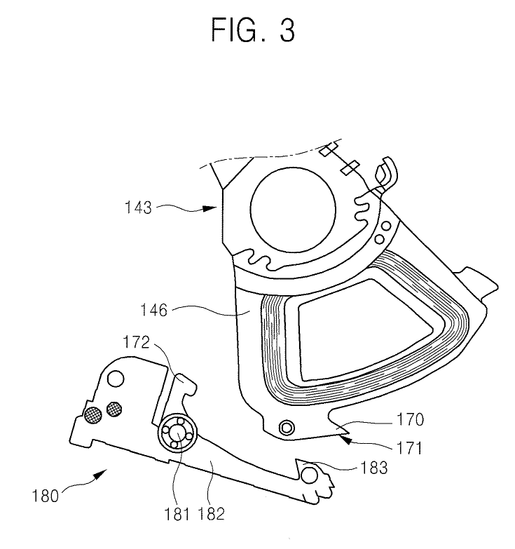

Thus, in the present embodiment, the latch lever time protrusion 88 is formed on a surface of the latch arm 82 to reduce the pivot distance of the latch lever 80 and the rebounding timing. That is, when the first latch prevention portion 183 of the latch lever 182 of FIG. 1 according to the prior art pivots a predetermined distance (the distance between the surface of the latch arm 182 facing the base and the inner wall of the base) around the pivot center portion and a predetermined rebounding time according thereto is consumed, in the latch lever 80 according to the present embodiment, the latch lever time protrusion 88 having a predetermined height is provided on the surface of the latch arm 82 facing the inner wall of the base 60 so that the latch lever 80 pivots a shorter distance, thus reducing the rebounding timing.

As illustrated in FIGS. 5 to 8, a base time protrusion 62 having a predetermined height is provided on an inner wall of the base 60 at a position corresponding to the latch lever time protrusion 88 so that the pivoting distance and rebounding timing of the latch lever 80 can be further reduced. Thus, the first catch portion 71 of the bobbin protruding portion 70 can be appropriately hooked by the first latch prevention portion 83 of the latch lever 80.

As described above, when at least one of the rebounding timings between the first to third latch hooks 83a, 83b, and 83c of the first latch prevention portion 83 of the latch lever 80 and the first catch portion 71 of the actuator arm 43 matches each other, the pivoting of the actuator arm 43 with respect to the latch lever 82 can be appropriately prevented.

However, when any of the rebounding timings between the first to third latch hooks 83a, 83b, and 83c of the first latch prevention portion 83 of the latch lever 80 and the first catch portion 71 of the actuator arm 43 does not match each other, the actuator arm 43 pivots toward the recording surface of the disk 11 so that the disk on pack phenomenon can be generated.

Thus, the latch apparatus 3 of the present embodiment includes the auxiliary catch portion 75 formed on the bobbin protruding portion 70 to prevent the pivoting of the actuator arm 43 when the rebounding time between the first catch portion 71 and the first latch prevention portion 83 does not match each other. For the convenience of explanation, the configuration of the bobbin protruding portion 70 is described and then the auxiliary catch portion 75 included in the bobbin protruding portion 70 is described.

The bobbin protruding portion 70 according to the present embodiment, as illustrated in FIGS. 7 and 8, includes the first catch portion 71 caught by the first latch prevention portion 83 having the first to third latch hooks 83a, 83b, and 83c, the second catch portion 72 caught by the second latch prevention portion 85 of the latch lever 80, and the auxiliary catch portion 75 which catches the first latch prevention portion 83.

First, the first catch portion 71 is a portion that is caught by the first latch hook 83a to the third latch hook 83c of the first latch prevention portion 83 and works as a major factor to prevent the pivoting of the actuator arm 43 when the rebounding timing is appropriately matched. Thus, the shape of the leading end portion of the first catch portion 71 and those of the first to third latch hooks 83a, 83b, and 83c are similar to one another. When the rebounding timing is appropriately matched so that the first catch portion 71 is caught by any of the first through third latch hooks 83a, 83b, and 83c, the latched state is maintained until a force in the opposite direction is applied to the actuator arm 43.

The second catch portion 72 is caught by the second latch prevention portion 85 to prevent the clockwise pivoting of the actuator arm 43. The second catch portion 72 and the second latch prevention portion 85 have shapes corresponding to each other to make an appropriate coupling.

As illustrated in FIGS. 7 and 8, the auxiliary catch portion 75 includes a plurality of auxiliary catch grooves 75a and 75b in an outer circumferential surface of the bobbin protruding portion 70 close to the first catch portion 71. The auxiliary catch portion 75 is a portion where the first latch prevention portion 83 is coupled when the coupling between the first catch portion 71 and the first latch prevention portion 83 fails. The reason to provide a plurality of the auxiliary catch grooves 75a and 75b is that, even when the first latch prevention portion 83 is not caught by the first auxiliary catch groove 75a located closest to the first catch portion 71, the first latch prevention portion 83 may be caught by the second auxiliary catch groove 75b located next to the first auxiliary catch groove 75a.

Also, to prevent self-unlocking by making locking more firm during the coupling, each of the auxiliary catch grooves 75a and 75b has a saw-toothed shape indented to a predetermined depth in a direction toward the pivot shaft 42, that is, the pivot center of the actuator arm 43. That is, a surface of each of the auxiliary catch grooves 75a and 75b where the first latch prevention portion 83 is supported when being coupled is formed in a direction along a normal of the outer circumferential surface of the bobbin protruding portion 70. The depth of the indent of the other surface of each auxiliary catch groove 75a and 75b gradually decreases from the one surface of the auxiliary catch groove 75a and 75b to the leading end of the first catch portion 71.

Accordingly, the first latch prevention portion 83 of the latch lever 80 pivoting counterclockwise moves along the inclined surface of each of the auxiliary catch grooves 75a and 75b and is finally caught by the one surface of each of the auxiliary catch grooves 75a and 75b. Each corner portion of each of the auxiliary catch grooves 75a and 75b may be round processed.

The bobbin protruding portion 70 has a first circumferencial length in a rotational direction of the actuator arm 43. The first catch portion 71 and the second catch portion 72 are formed at opposite ends of the bobbin protruding portion 70 and spaced-apart from each other by about the circumferential length. The auxiliary catch portion 75 is formed on the bobbin protruding portion 70 and spaced apart from the first catch portion 71 by a second circumference length shorter than the first circumferencial length. The bobbin protruding portion 70 rotates with respect to the shaft 42 by a first angle, and the auxiliary catch portion 75 is disposed within a second angle smaller than the first angle to be caught by the first latch prevention portion 83 when the actuator arm 43 rotates by the second angle.

Thus, when the rebounding timing is not matched so that the first catch portion 71 of the bobbin protruding portion 70 fails to catch the first latch prevention portion 83, the first latch prevention portion 83 can be secondarily coupled to the auxiliary catch portion 75 configured as described above so that the pivoting of the actuator arm 43 is prevented. As a result, the disk on pack phenomenon is remarkably reduced so that the locking failure is prevented and further the reliability in locking and unlocking operations is improved.

In the locking operation of the actuator latch apparatus 3 of the HDD 1 configured as described above, first, when an operation of the HDD 1 is stopped and the read/write head 41 mounted on the leading end portion of the actuator arm 43 is parked on the ramp 90, the actuator arm 43 rotates clockwise around the pivot shaft 42 by the VCM 50. The first catch portion 71 of the bobbin protruding portion 70 formed at the rear end portion of the actuator arm 43 is coupled to the first latch hook 83a of the first latch prevention portion 83. That is, as the first latch hook 83a catches the first catch portion 71, and thus, the unlocking of the actuator arm 43 can be prevented.

When a rotary shock is applied to the HDD 1, the actuator arm 43 rotates clockwise, bumps with the second latch prevention portion 85, and is rebounded to pivot counterclockwise. Simultaneously, the latch lever 80 pivots clockwise around the pivot center portion 81 and the latch lever time protrusion 88 is rebounded by the base time protrusion 62 to pivot counterclockwise.

In the operation, when the rebounding timings of the actuator arm 43 and the latch lever 80 are matched, the first catch portion 71 of the bobbin protruding portion 70 is caught by the first latch hook 83a of the first latch prevention portion 83. When the rebounding timing of the latch lever 80 is longer than that of the actuator arm 43, the first catch portion 71 of the bobbin protruding portion 70 is caught by the second or third latch hook 83b or 83c after passing the first latch hook 83a. Due to this operation, even when a rotary shock is applied to the HDD 1, the latch lever 80 can appropriately prevent the pivoting of the actuator arm 43.

However, when the rebounding timing of the latch lever 80 is longer than that of the bobbin protruding portion 70, the first catch portion 71 is not caught by the first to third latch hooks 83a, 83b, and 83c. Accordingly, as illustrated in FIG. 8, the first latch prevention portion 83 of the latch lever 80 is caught by any one of the auxiliary catch grooves 75a and 75b of the auxiliary catch portion 75 of the bobbin protruding portion 70.

According to the present embodiment, when the rebounding timings of the actuator arm 43 and the latch lever 80 are not accurately matched, since the bobbin protruding portion 70 and the latch lever 80 are auxiliarily coupled, the disk on pack phenomenon generated due to the failure of the locking between the latch lever 80 and the actuator arm 43 can be prevented. Also, the reliability of the HDD 1 can be improved.

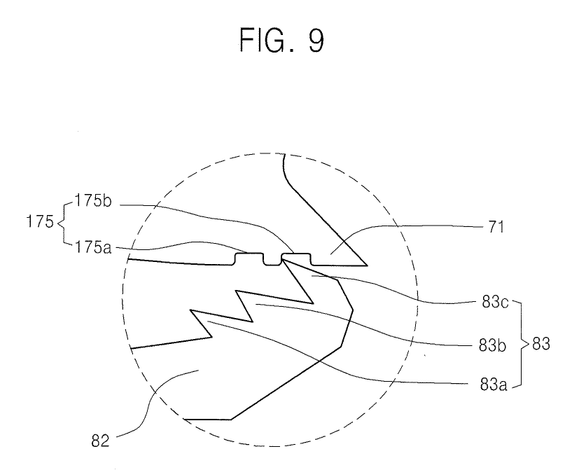

FIG. 9 illustrates the uneven shape of the auxiliary catch portion of an HDD according to another embodiment of the present general inventive concept. Referring to FIG. 9, an auxiliary catch portion 175 includes auxiliary catch grooves 175a and 175b that may be manufactured with an uneven shape.

The auxiliary catch grooves 175a and 175b can appropriately catch the first latch prevention portion 83 like the auxiliary catch grooves 75a and 75b of FIGS. 7 and 8 so that the auxiliary coupling between the bobbin protruding portion 70 and the latch lever 80 can be made. Accordingly, the disk on pack phenomenon can be prevented and the reliability of the HDD 1 can be improved.

In the above-described embodiments, although the first latch prevention portion includes the first to third latch hooks and the first catch portion of the bobbin protruding portion is sequentially caught thereby, the number of the latch hooks can be more or less than three, if necessary.

Although a few embodiments of the present general inventive concept have been illustrated and described, the present general inventive concept is not limited to the described embodiments. Instead, it would be appreciated by those skilled in the art that changes may be made to these embodiments without departing from the principles and spirit of the general inventive concept, the scope of which is defined by the claims and their equivalents.

According to the above-described embodiments of the present general inventive concept, the disk on pack phenomenon that the leading end portion of the actuator arm moves over the recording surface of the disk when the actuator arm is rebounded due to a rotary shock is reduced with a simple and easy to make structure to prevent a locking failure. Thus, the reliability in the locking and unlocking operations is improved.

What is claimed is:

1. An actuator latch apparatus usable with a hard disk drive apparatus, the actuator latch apparatus comprising:
a latch lever disposed on a base to pivot thereon and having a first latch prevention portion to prevent pivoting of an actuator arm in a direction, the actuator arm having a bobbin formed at a rear end portion thereof; and
a bobbin protruding portion having a first catch portion provided at the bobbin and an auxiliary catch portion provided at the bobbin separated from the first catch portion to lock with the first latch prevention portion when the first catch portion is not caught by the first latch prevention portion.

2. The actuator latch apparatus of claim 1, wherein the auxiliary catch portion comprises:
at least one auxiliary catch groove formed indented on a side surface of the bobbin protruding portion toward the bobbin.

3. The actuator latch apparatus of claim 2, wherein the at least one auxiliary catch groove has a saw-toothed shape in which a depth of the indent gradually decreases toward the first latch prevention portion of the latch lever.

4. The actuator latch apparatus of claim 2, wherein corner portions of the at least one auxiliary catch groove are round processed.

5. The actuator latch apparatus of claim 2, wherein the at least one auxiliary catch groove is provided in a plural number close to the first catch portion to be separated from each other along a side surface of the bobbin protruding portion facing the latch lever.

6. The actuator latch apparatus of claim 1, wherein the latch lever further comprises a latch arm disposed on the base to pivot thereon and having the first latch prevention portion provided at an end portion, and the first latch prevention portion comprises:
a first latch hook protruding from an end portion of the latch arm; and
a second latch hook protruding from the latch arm at a position close to the first latch hook.

7. The actuator latch apparatus of claim 6, wherein the first latch prevention portion further comprises:
a third latch hook protruding from the latch arm at a position close to the second latch hook.

8. The actuator latch apparatus of claim 1, wherein a latch lever time protrusion protrudes from a surface of the latch lever facing an inner wall of the base and a base time protrusion is provided on the base facing the latch lever time protrusion so that the latch lever time protrusion contacts the base time protrusion before the latch lever rotates in a direction and is rebounded to return to an original position.

9. The actuator latch apparatus of claim 1, wherein the latch lever further comprises:
a second latch prevention portion coupled to the second catch portion provided at an opposite side of the first catch portion of the bobbin protruding portion, to prevent the pivoting of the actuator arm in an other direction.

10. The actuator latch apparatus of claim 9, wherein the latch lever further comprises:
a buffer arm provided by a slot formed at a side of the latch lever;
and the second latch prevention portion is provided at the buffer arm.

11. A hard disk drive apparatus, comprising:
a base;
an actuator arm disposed on a base to pivot thereon and having a bobbin formed at a rear end portion thereof;
a latch lever disposed on the base to pivot thereon and having a first latch prevention portion to prevent pivoting of an actuator arm in a direction; and
a bobbin protruding portion having a first catch portion provided at the bobbin and an auxiliary catch portion provided at the bobbin separated from the first catch portion to lock with the first latch prevention portion when the first catch portion is not caught by the first latch prevention portion.

12. The hard disk drive apparatus of claim 11, wherein the auxiliary catch portion comprises:
at least one auxiliary catch groove formed indented on a side surface of the bobbin protruding portion toward the bobbin.

13. The hard disk drive apparatus of claim 12, wherein the at least one auxiliary catch groove has a saw-toothed shape in which a depth of the indent gradually decreases toward the first latch prevention portion of the latch lever.

14. The hard disk drive apparatus of claim 12, wherein corner portions of the at least one auxiliary catch groove are round processed.

15. The hard disk drive apparatus of claim 12, wherein the at least one auxiliary catch groove is provided in a plural number close to the first catch portion to be separated from each other along a side surface of the bobbin protruding portion facing the latch lever.

16. The hard disk drive apparatus of claim 11, wherein the latch lever further comprises a latch arm disposed on the base to pivot thereon and having the first latch prevention portion provided at an end portion, and the first latch prevention portion comprises:
a first latch hook protruding from an end portion of the latch arm; and
a second latch hook protruding from the latch arm at a position close to the first latch hook.

17. The hard disk drive apparatus of claim 16, wherein the first latch prevention portion further comprises:
a third latch hook protruding from the latch arm at a position close to the second latch hook.

18. The hard disk drive apparatus of claim 11, wherein a latch lever time protrusion protrudes from a surface of the latch lever facing an inner wall of the base and a base time protrusion is provided on the base facing the latch lever time protrusion so that the latch lever time protrusion contacts the base time protrusion before the latch lever rotates in a direction and is rebounded to return to an original position.

19. The hard disk drive apparatus of claim 11, wherein the latch lever further comprises:
a second latch prevention portion coupled to the second catch portion provided at an opposite side of the first catch portion of the bobbin protruding portion to prevent the pivoting of the actuator arm in an other direction.

20. The hard disk drive apparatus of claim 19, wherein the latch lever further comprises:
a buffer arm provided by a slot formed at a side of the latch lever and the second latch prevention portion is provided at the buffer arm.

21. A latch apparatus usable with a disk drive apparatus having a base, the latch apparatus comprising:
a latch lever pivotably coupled to the base and having one of a plurality of prevention portions and a plurality of catch portions; and
an actuator arm pivotably coupled to the base portion and having the other one of the plurality of prevention portions and the plurality of catch portions;
wherein a respective one of the plurality of prevention portions and a respective one of the plurality of catch portions engage each other to limit at least one of a clockwise direction and a counterclockwise direction of the actuator arm in response to a shock applied to the disk drive apparatus while in a parking mode.

22. A disk drive apparatus having a parking mode, the apparatus comprising:
a base; and
a latch apparatus usable with a disk drive apparatus comprising:
a latch lever pivotably coupled to the base and having one of a plurality of prevention portions and a plurality of catch portions; and
an actuator arm pivotably coupled to the base portion and having the other one of the plurality of prevention portions and the plurality of catch portions;
wherein a respective one of the plurality of prevention portions and a respective one of the plurality of catch portions engage each other to limit pivoting of the actuator arm in at least one of a clockwise direction and a counterclockwise direction in response to a shock applied to the disk drive apparatus while in the parking mode.

23. The apparatus of claim 22, wherein the plurality of prevention portions are disposed on the latch lever and comprise a first latch prevention portion having a plurality of latch hooks, a second latch prevention portion and a third latch prevention portion.

24. The apparatus of claim 23, wherein the plurality of catch portions are disposed on the actuator arm and comprise a first catch portion, a second catch portion and an auxiliary catch portion.

25. The apparatus of claim 24, wherein the auxiliary catch portion limits the pivoting of the actuator arm in the counterclockwise direction when a rebounding time of the first catch portion and the first latch prevention portion are not substantially equal and the disk drive apparatus is in the parking mode.

26. The apparatus of claim 24, wherein the first latch hook limits the pivoting of the actuator arm in the counterclockwise direction when a rebounding time of a first one of the plurality of latch hooks is substantially equal to a rebounding time of the first catch portion and the disk drive apparatus is in the parking mode.

27. The apparatus of claim 24, wherein the second latch hook limits the pivoting of the actuator arm in the counterclockwise direction when a rebounding time of a second one of the plurality of latch hooks is substantially equal to a rebounding time of the first catch portion and the disk drive apparatus is in the parking mode.

28. The apparatus of claim 24, wherein the third latch hook limits the pivoting of the actuator arm in the counterclockwise direction when a rebounding time of a third of the plurality of latch hooks is substantially equal to a rebounding time of the first catch portion and the disk drive apparatus is in the parking mode.

29. The apparatus according to claim 24, wherein the first latch prevention portion limits the arbitrary pivoting of the actuator arm in the counterclockwise direction and the second latch prevention portion limits the arbitrary pivoting of the actuator arm in the clockwise direction when the disk drive apparatus is in the parking mode.

30. A latch apparatus usable with a disk drive apparatus, comprising:
a latch lever having latch prevention portion; and
an actuator arm having a bobbin protruding portion having a first circumferential length in a rotation direction of the actuator arm, and first and second catch portions disposed on the bobbin protruding portion and spaced-apart from each other by a second circumferencial length shorter than the first circumferencial length in the rotational direction of the actuator arm selectively caught by the latch lever.
